(19) United States
(12) Patent Application Publication
(10) Pub. No.: US 2022/0223062 A1
(43) Pub. Date: Jul. 14, 2022

(54) LEARNING SUPPORT DEVICE, LEARNING SUPPORT METHOD AND PROGRAM

(71) Applicant: NIPPON TELEGRAPH AND TELEPHONE CORPORATION, Tokyo (JP)

(72) Inventors: Midori KODAMA, Musashino-shi, Tokyo (JP); Ippei SHAKE, Musashino-shi, Tokyo (JP); Takahiro HATA, Musashino-shi, Tokyo (JP)

(73) Assignee: NIPPON TELEGRAPH AND TELEPHONE CORPORATION, Tokyo (JP)

(21) Appl. No.: 17/291,201

(22) PCT Filed: Oct. 23, 2019
(86) PCT No.: PCT/JP2019/041536

§ 371 Date: Jan. 25, 2022

(30) Foreign Application Priority Data
Nov. 5, 2018 (JP) 2018-208345

(51) Int. Cl. G09B 7/08

(52) U.S. Cl. CPC G09B 7/08

(57) ABSTRACT

Provided is a learning support device capable of providing highly reliable parameter estimation. A learning support device for supporting user learning acquires correct/incorrect answer data indicating whether each of answers from a plurality of users to a plurality of items to be learned is correct or incorrect, and calculates, based on the acquired correct/incorrect answer data, a proficiency level indicating an ability level of each user, a difficulty level indicating a difficulty of each item, and reliabilities indicating reliability levels of the proficiency level and the difficulty level. The learning support device also generates a trigger for instructing to update at least one of the calculated proficiency level or difficulty level, and uses, as a reference parameter, at least one of a proficiency level or a difficulty level which has a reliability exceeding a first threshold value among the calculated proficiency levels or difficulty levels to recalculate, in response to the generated trigger, at least one of the proficiency level or the difficulty level which is instructed to be updated by the trigger.

### TECHNICAL FIELD

One aspect of the present invention relates to a learning support device, a learning support method, and a program for supporting user learning.

### BACKGROUND ART

In learning systems including an online learning system, a method of evaluating a user's learning ability is used to support user learning. As one of methods of evaluating learning abilities, there is known item response theory for measuring, based on a user's response to a group of assessment items, the user's ability and the difficulty level of each evaluation item.

According to item response theory, the characteristics (difficulty level) of questions answered by a plurality of users (subjects) and the ability (understanding level or proficiency level) of each user are treated at once so that the degree of understanding of each user can be evaluated and their evaluation results can be compared without the users taking the same tests (e.g., see NPL 1). There is also known a learning system that uses such a method of estimating understanding levels of users to present a question with a difficulty level corresponding to the estimated understanding level (e.g., see NPL 2).

### CITATION LIST

### Non Patent Literature

[NPL 1] Yuki Tsukihara, Keiichi Suzuki, and Hideo Hirose, “A small implementation case of the mathematics tests with the Item Response Theory evaluation into an e-learning system”, Computer & Education 24 (2008), 70-76.

[NPL 2] Chen, Chih-Ming, Hahn-Ming Lee, and Ya-Hui Chen, “Personalized e-learning system using item response theory”, Computers & Education 44.3 (2005), 237-255.

### SUMMARY OF THE INVENTION

### Technical Problem

In a case of using item response theory, the ability of a user and the characteristics of a question can be estimated by the following manner.

First, the probability Pᵢⱼ of a user j answering an item i correctly can be expressed by the following Equation 1 using a subject parameter θⱼ and an item parameter bᵢ.

$$\begin{matrix}( Equation 1 ) & \\ {P}_{ij} = \frac{1}{1 + exp [ - ( {θ}_{j} - {b}_{i} ) ]} & [ Formula 1 ]\end{matrix}$$

This model is generally called the one-parameter logistic (1PL) model (the Rasch model). The subject parameter θⱼ represents the ability value of each user (hereinafter, referred to as “proficiency level”). An “item” refers to one question, which is each of the questions, in learning, and the item parameter bᵢ represents the difficulty of each item (hereinafter referred to as the “difficulty level”).

Then, these parameters can be estimated from a likelihood obtained by the following Equation 2, where uᵢⱼ is a response from a user j who has performed an item i. Note that uᵢⱼ takes a value of 1 for a correct answer and 0 for an incorrect answer.

$$\begin{matrix}( Equation 2 ) & \\ L ( {u}_{ij} \vert {θ}_{j} , {b}_{i} ) = {\prod }_{i = 1}^{I} {\prod }_{j = 1}^{J} {{P}_{ij}^{{u}_{ij}} ( 1 - {P}_{ij} )}^{( 1 - {u}_{ij} )} & [ Formula 2 ]\end{matrix}$$

It is known that when both the proficiency level and the difficulty level are unknown, the simultaneous maximum likelihood estimation method, the marginal maximum likelihood estimation method, the Bayesian estimation method, and the like can be used for estimation.

Incidentally, in a system in which each user freely selects and answers an item and correct/incorrect answer data indicating whether the answer is correct or incorrect is obtained, such as an online service teaching material distribution system, when the number of users or the number of items increases or decreases, it is necessary to calculate the proficiency level of a new user and the difficulty level parameter for a new additional item. In this case, if the calculation based on item response theory is only performed on all the data by using conventional techniques, the scales for proficiency level and difficulty level are changed every time the proficiency level and the difficulty level are estimated, which causes a problem (Problem 0) that the levels cannot be compared with previously calculated parameters. For example, considering adding data later for similar items, if there are many correct answers to the added data (high correct answer rate), the difficulty level is estimated to be lower than before, and accordingly it is easy to underestimate the proficiency level.

In order to solve this problem (Problem 0), it is necessary to calculate the proficiency level of a new user and the difficulty level of a new item without changing the initially calculated scale for difficulty level. Specifically, for a new user or an existing user who has new correct/incorrect answer data, it is possible to substitute the already calculated difficulty level into Equation 2 described above to obtain the proficiency level by a method such as maximum likelihood estimation. Similarly, for a new item or an existing item which has new correct/incorrect answer data, it is also possible to substitute the already calculated proficiency level into Equation 2 to obtain the difficulty level by a method such as maximum likelihood estimation. However, with these methods alone, the following problems remain and the accuracy of the parameters cannot be guaranteed.

(Problem 1) Lowered Reliability of Proficiency Level Estimation Due to a Variation in the Reliability of the Difficulty Level

For items each having a small number of answers and for items each having a high number of correct answers but each having a too high or too low correct answer rate, the reliability of the difficulty levels calculated by item response theory becomes low. In a case of using calculated difficulty levels to estimate the proficiency level of a new user or an existing user who has new correct/incorrect answer data, if some of the calculated difficulty levels have low reliability, the reliability of a newly estimated proficiency level becomes also low.

(Problem 2) Lowered Reliability of Difficulty Level Estimation Due to a Variation in the Reliability of the Proficiency Level

If the number of answers from users is small, or if the correct answer rate is too high or too low, the reliability of the calculated proficiency level becomes low. Also, in a case where it is assumed that there are users who use the service for a long period of time, even if those users are proficient and their proficiency levels differ greatly between the initial state and final state, such users need to be treated as a single user having a same proficiency level parameter, and it is considered than the reliability of the proficiency level is low also in such a case.

In a case of using calculated proficiency levels to estimate the difficulty level of a new item or an existing item which has new correct/incorrect answer data, if some of the calculated proficiency levels have low reliability, the reliability of a newly estimated difficulty level becomes also low.

(Problem 3) Small Amount of Data When Initial Scale for Difficulty Level is Fixed

Since the correct/incorrect answer data used for fixing an initial scale for difficulty level is a small amount of data accumulated at the initial stage of the service, the parameters estimated based on them may be uncertain estimates. It may be desirable to update each parameter to an estimate using many pieces of correct/incorrect answer data when necessary.

The present invention has been made in view of the above circumstances, and an object thereof is to provide a learning support device, a learning support method, and a program that are capable of providing highly reliable parameter estimation.

### Means for Solving the Problem

In order to solve the above problems, a first aspect of the present invention is a learning support device for supporting user learning, the learning support device including: a correct/incorrect answer data acquisition unit that acquires correct/incorrect answer data indicating whether each of answers from a plurality of users to a plurality of items to be learned is correct or incorrect; a parameter calculation unit that calculates, based on the acquired correct/incorrect answer data, a proficiency level indicating an ability level of each user, a difficulty level indicating a difficulty of each item, and reliabilities indicating reliability levels of the proficiency level and the difficulty level; a trigger generation unit that generates a trigger for instructing to update at least one of the calculated proficiency level or difficulty level; and an update control unit that uses, as a reference parameter, at least one of a proficiency level or a difficulty level which has a reliability exceeding a first threshold value among the calculated proficiency levels or difficulty levels to recalculate, in response to the generated trigger, at least one of the proficiency level or the difficulty level which is instructed to be updated by the trigger.

In a second aspect of the present invention according to the learning support device of the first aspect, when the number of pieces of correct/incorrect answer data that have not been used for calculating the proficiency level of a specific user exceeds a first number, when an instruction to update the proficiency level of the specific user is received, or when the reliability of the calculated proficiency level of the specific user is lower than a second threshold value and there is any piece of correct/incorrect answer data that has not been used for calculating the proficiency level of the specific user, the trigger generation unit generates a proficiency level update trigger for instructing to update the proficiency level of the specific user.

In a third aspect of the present invention according to the learning support device of the first aspect, when the number of pieces of correct/incorrect answer data that have not been used for calculating the difficulty level of a specific item exceeds a second number, when an instruction to update the difficulty level of the specific item is received, or when the reliability of the calculated difficulty level of the specific item is lower than a third threshold value and there is any piece of correct/incorrect answer data that has not been used for calculating the difficulty level of the specific item, the trigger generation unit generates a difficulty level update trigger for instructing to update the difficulty level of the specific item.

In a fourth aspect of the present invention according to the learning support device of the first aspect, when the cumulative number of pieces of correct/incorrect answer data acquired by the correct/incorrect answer data acquisition unit reaches a natural number multiple of a third number, when an instruction to update the proficiency level and the difficulty level at once is received, when an average value of the reliabilities of the proficiency levels of all users or an average value of the reliabilities of the difficulty levels of all items is lower than a fourth threshold value, a ratio of reliabilities that are each lower than a fifth threshold value to the reliabilities of the proficiency levels of all users or among the reliabilities of the difficulty levels of all items exceeds a sixth threshold value, or a coincidence rate between a correct answer rate calculated from the correct/incorrect answer data acquired by the correct/incorrect answer data acquisition unit and a correct answer rate calculated using a relational expression based on the proficiency level and the difficulty level calculated by the parameter calculation unit is lower than a seventh threshold value, the trigger generation unit generates a simultaneous update trigger for instructing to update the proficiency level and the difficulty level at once.

In a fifth aspect of the present invention according to the learning support device of the first aspect, the update control unit calculates, when the trigger instructs to update the proficiency level of a specific user, a new proficiency level based on a piece of correct/incorrect answer data that has not been used for calculating the proficiency level among pieces of correct/incorrect answer data that have user identification information associated with the specific user, and the update control unit adds, when a difference between the new proficiency level and the previously calculated proficiency level is larger than an eighth threshold value, new user identification information different from the user identification information of the specific user to the new proficiency level and the piece of correct/incorrect answer data used for calculating the new proficiency level.

In a sixth aspect of the present invention according to the learning support device of the first aspect, the update control unit updates the proficiency level or the difficulty level by multiplying the recalculated proficiency level or difficulty level by a weight coefficient and multiplying the previously calculated proficiency level or difficulty level by a weight coefficient and adding the resulting levels, or by taking a moving average based on the recalculated proficiency level or difficulty level and the previously calculated proficiency level or difficulty level.

### Effects of the Invention

According to the first aspect of the present invention, a proficiency level of each user, a reliability of the proficiency level, a difficulty level of each item and a reliability of the difficulty level are calculated based on acquired correct/incorrect answer data, and in response to a trigger for instructing to update at least one of the proficiency level or the difficulty level, the parameter instructed to be updated by the trigger is recalculated using the parameter with a high reliability as a reference parameter. As a result, in calculating an item difficulty level and a user proficiency level which are evaluated on the same scale for difficulty level as the initially calculated scale for difficulty level, an uncertain parameter due to roughness and fineness of data of each user or item is removed by using a reliability evaluation of the parameter, thereby making it possible to calculate a more certain parameter.

Accordingly, with respect to the above-mentioned Problem 1, it is possible to provide highly reliable proficiency level estimation for a new user or an existing user who has new correct/incorrect answer data by removing the difficulty level with a low reliability using a reliability evaluation of the calculated difficulty level and by using only the difficulty level with a high reliability as the reference parameter.

Further, with respect to the above-mentioned Problem 2, it is possible to provide highly reliable difficulty level estimation for a new item or an existing item who has new correct/incorrect answer data by removing the proficiency level with a low reliability using a reliability evaluation of the calculated proficiency level and by using only the proficiency level with a high reliability as the reference parameter.

According to the second aspect of the present invention, when correct/incorrect answer data of a new user is obtained or correct/incorrect answer data of an existing user increases, when a request from a user, a system administrator, or the like or an instruction for scheduled update is received, or when the reliability of the proficiency level of a specific user is low and there is new correct/incorrect answer data of the specific user, a trigger for instructing to update the proficiency level is generated. This makes it possible to appropriately generate and output a trigger for instructing to update the proficiency level in a situation where the proficiency level needs to be updated.

According to the third aspect of the present invention, when correct/incorrect answer data of a new item is obtained or correct/incorrect answer data of an existing item increases, when a request from a user, a system administrator, or the like or an instruction for scheduled update is received, or when the reliability of the difficulty level of a specific item is low and there is new correct/incorrect answer data of the specific item, the trigger for instructing to update the difficulty level is generated. This makes it possible to appropriately generate and output a trigger for instructing to update the difficulty level in a situation where the difficulty level needs to be updated.

According to the fourth aspect of the present invention, when the cumulative number of acquired pieces of correct/incorrect answer data increases, when a request from a user, a system administrator, or the like or an instruction for scheduled update is received, when an average value of the reliabilities of the calculated difficulty levels or proficiency levels is low, when a ratio of the difficulty levels or proficiency levels with a low reliability to the total increases, or when a coincidence rate between a correct answer rate obtained from the actual correct/incorrect answer data and a correct answer rate obtained from a relational expression using the calculated parameters is low, a trigger for instructing to update the proficiency level and the difficulty level at once is generated. This makes it possible to appropriately generate and output a trigger for instructing to update the proficiency level and the difficulty level at once in a situation where the proficiency level and the difficulty level needs to be updated at once.

According to the fifth aspect of the present invention, when a new proficiency level is calculated for a specific user by using a piece of correct/incorrect answer data that has not been used for calculating the proficiency level in response to a trigger for instructing to update the proficiency level, if a difference between the new proficiency level and the previous proficiency level is large, user identification information different from the user identification information of the specific user is added to the new proficiency level and the piece of correct/incorrect answer data used for calculating the new proficiency level. When there is any long-term users or when there is found a large change in the proficiency level of a user, it is difficult to express the user's characteristics with a single proficiency level, and it is expected that the degree of conformity between the model and actual data decreases. However, by using the above method, data which is actually of a single user is treated as if it were the data of another user with a different proficiency level, thereby making it possible to reduce the discrepancy between the model and the data and increase the accuracy of estimating each parameter while performing proficiency level estimation according to the actual change in the proficiency level of the user.

According to the sixth aspect of the present invention, the proficiency level or the difficulty level is recalculated using a highly reliable reference parameter, and a new update parameter is obtained by multiplying the newly calculated parameter by a weight coefficient and multiplying the previously calculated parameter by a weight coefficient and adding the resulting parameters, or by taking a moving average of the newly calculated parameter and the previously calculated parameter. As a result, the newly calculated proficiency level or difficulty level is not used as it is, but the calculation in consideration of a change with time of the previously calculated proficiency level or difficulty level is performed, and then the update is performed. Therefore, even when data of a new user or a new item is generated, the difficulty level and the proficiency level can be calculated without a discrepancy with the previously calculated scale for difficulty level, and the proficiency level and the difficulty level of an item to be presented to the user can be used without any discomfort even as compared with the parameters calculated before new data is generated.

Thus, according to each aspect of the present invention, it is possible to provide a learning support device, a learning support method, and a program that are capable of providing highly reliable parameter estimation.

### BRIEF DESCRIPTION OF DRAWINGS

FIG. 1 is a block diagram illustrating a functional configuration of a learning support device according to an embodiment of the present invention.

FIG. 2 is a block diagram illustrating a detailed configuration of a proficiency level update control unit of functional units included in the learning support device illustrated in FIG. 1.

FIG. 3 is a block diagram illustrating a detailed configuration of a difficulty level update control unit of functional units included in the learning support device illustrated in FIG. 1.

FIG. 4 is a block diagram illustrating a detailed configuration of a simultaneous update control unit of functional units included in the learning support device illustrated in FIG. 1.

FIG. 5 is a flowchart illustrating an example of a processing procedure of initial parameter calculation performed by the learning support device illustrated in FIG. 1 and an example of its processing content.

FIG. 6 is a flowchart illustrating a first example of a processing procedure of proficiency level update performed by the learning support device illustrated in FIG. 1 and its processing content.

FIG. 7 is a flowchart illustrating a second example of a processing procedure of proficiency level update performed by the learning support device illustrated in FIG. 1 and its processing content.

FIG. 8 is a flowchart illustrating an example of a processing procedure of difficulty level update performed by the learning support device illustrated in FIG. 1 and its processing content.

FIG. 9 is a flowchart illustrating an example of a processing procedure of updating the proficiency level and the difficulty level at once by the learning support device illustrated in FIG. 1 and its processing content.

FIG. 10 is a diagram illustrating an example of correct/incorrect answer data.

FIG. 11 is a diagram illustrating an example of proficiency level and reliability data.

FIG. 12 is a diagram illustrating an example of difficulty level and reliability data.

FIG. 13 is a diagram illustrating an example of an update trigger table defining a trigger for instructing update.

### DESCRIPTION OF EMBODIMENTS

Hereinafter, embodiments according to the present invention will be described with reference to the drawings.

[Embodiment]

### I. Configuration

(1) Overall Configuration

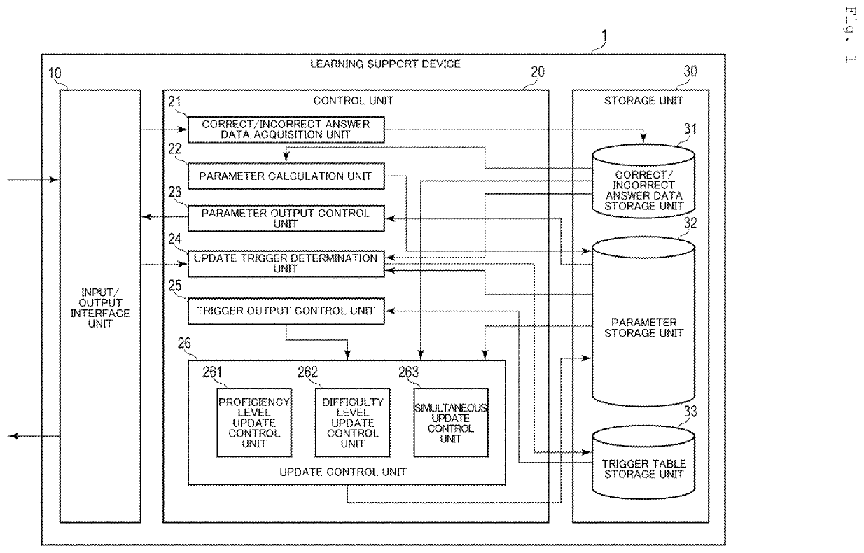

FIG. 1 is a block diagram illustrating a functional configuration of a learning support device 1 according to an embodiment of the present invention.

The learning support device 1 is used, for example, as a part of an online learning system provided by an educational institution such as a university or by an educational service provider, and includes, for example, a server computer or a personal computer. The learning support device 1 acquires correct/incorrect answer data indicating whether answers from a plurality of users to a plurality of questions (items) are each correct or incorrect (a correct answer or incorrect answer), via a communication network, an input device, or the like. Then, the learning support device 1 can calculate various parameters based on the acquired correct/incorrect answer data and output the calculated parameters as appropriate, thereby supporting user learning.

The learning support device 1 according to an embodiment includes an input/output interface unit 10, a control unit 20, and a storage unit 30.

The input/output interface unit 10 includes, for example, one or more wired or wireless communication interface units, and enables transmission and reception of information to and from an external device. As the wired interface, for example, a wired LAN is used, and as the wireless interface, for example, an interface that adopts a low-power wireless data communication standard such as wireless LAN or Bluetooth (registered trademark) is used.

For example, the learning support device 1 captures pieces of correct/incorrect answer data collected by the online learning system via the input/output interface unit 10 at a constant amount or at regular time intervals, and passes the captured data to the control unit 20. The input/output interface unit 10 also performs processing of capturing an instruction or the like input through an input device (not illustrated) such as a keyboard and passing it to the control unit 20. Further, the input/output interface unit 10 can perform processing of outputting a parameter calculation result output from the control unit 20 to a display device (not illustrated) for presentation to a user or an operator, and processing of transmitting the parameter calculation result to an external device via a network.

The storage unit 30 is configured using, as a storage medium, a non-volatile memory capable of writing and reading at any time, such as an HDD (Hard Disk Drive) or an SSD (Solid State Drive), for example. The storage unit 30 is also provided with a correct/incorrect answer data storage unit 31, a parameter storage unit 32, and a trigger table storage unit 33, in addition to a program storage unit, as storage areas necessary for implementing the present embodiment.

The correct/incorrect answer data storage unit 31 stores a correct/incorrect answer data table that stores correct/incorrect answer data acquired through the input/output interface unit 10.

The parameter storage unit 32 stores various parameters calculated based on the acquired correct/incorrect answer data. The parameter storage unit is used in particular to store a proficiency level table that stores calculated proficiency levels and their reliabilities, and a difficulty level table that stores calculated difficulty levels and their reliabilities.

The trigger table storage unit 33 stores an update trigger table that defines update triggers.

However, the storage units 31 to 33 are not indispensable components, and the learning support device 1 may acquire necessary data from an external device at any time. Alternatively, the storage units 31 to 33 do not have to be built in the learning support device 1, and may be provided, for example, in an external storage medium such as a USB memory, or a storage device such as a database server deployed on cloud.

The control unit 20 includes a hardware processor such as a CPU (Central Processing Unit.) or an MPU (Micro Processing Unit) (not illustrated), and a memory such as a DRAM (Dynamic Random Access Memory) or an SRAM (Static Random Access Memory). The control unit 20 is also provided with, as processing functions necessary for carrying out the present embodiment, a correct/incorrect answer data acquisition unit 21, a parameter calculation unit 22, a parameter output control unit 23, an update trigger determination unit 24, and a trigger output control unit 25, and an update control unit 26. Each of these processing functions is implemented by causing the processor to execute a program stored in the storage unit 30. The control unit 20 may also be configured in various other forms including an integrated circuit such as an ASIC (Application Specific Integrated Circuit) and an FPGA (field-programmable gate array).

The correct/incorrect answer data acquisition unit 21 performs processing of acquiring correct/incorrect answer data via the input/output interface unit 10 and storing it in the correct/incorrect answer data storage unit 31.

The parameter calculation unit 22 reads pieces of correct/incorrect answer data stored in the correct/incorrect answer data storage unit 31, calculates various parameters based on the read pieces of correct/incorrect answer data, and stores the calculated parameters in the parameter storage unit 32. In the embodiment, the parameter calculation unit 22 uses item response theory described above to calculate a proficiency level indicating the ability level of each user and a difficulty level indicating the difficulty of each item, and further calculate a reliability indicating a reliability level of each of the calculated proficiency level and difficulty level.

The parameter output control unit 23 performs processing of generating output data based on the parameters stored in the parameter storage unit 32 and outputting the data to a display device or an external device via the input/output interface unit 10. For example, the parameter output control unit 23 can generate output data including the difficulty level of each item and the proficiency level of each user and output it in response to a request from an external application, such as of a learning system or a musical instrument playing support system.

The update trigger determination unit 24 performs processing of determining whether or not a calculated parameter stored in the parameter storage unit 32 needs to be updated, and writing the determination result in the trigger table stored in the trigger table storage unit 33.

The trigger output control unit 25 performs processing of referring to the trigger table stored in the trigger table storage unit 33 to generate a necessary update trigger and output it to the update control unit 26.

The update control unit 26 receives the update trigger output from the trigger output control unit 25 and performs update control processing according to the received update trigger. The update control unit 26 also includes a proficiency level update control unit 261, a difficulty level update control unit 262, and a simultaneous update control unit 263.

The proficiency level update control unit 261 performs processing calculating, in response to a proficiency level update trigger output from the trigger output control unit 25 for instructing to update the proficiency level, a proficiency level based on a scale for difficulty level stored in the parameter storage unit 32 by using the correct/incorrect answer data stored in the correct/incorrect answer data storage unit 31 and the difficulty level stored in the parameter storage unit 32. Here, the scale for difficulty level represents a scale of where the difficulty level is located in a difficulty level range, which is set to, for example, −4 to +4, in order to compare difficulty levels of items.

The difficulty level update control unit 262 performs processing calculating, in response to a difficulty level update trigger output from the trigger output control unit 25 for instructing to update the difficulty level, a difficulty level based on a scale for difficulty level stored in the parameter storage unit 32 by using the correct/incorrect answer data stored in the correct/incorrect answer data storage unit 31 and the proficiency level stored in the parameter storage unit 32.

The simultaneous update control unit 263 performs processing calculating, in response to a simultaneous update trigger output from the trigger output control unit 25 for instructing to update the proficiency level and the difficulty level at once, a proficiency level and a difficulty level by using the correct/incorrect answer data stored in the correct/incorrect answer data storage unit 31 and the parameters stored in the parameter storage unit 32.

(2) Configuration of Proficiency Level Update Control Unit

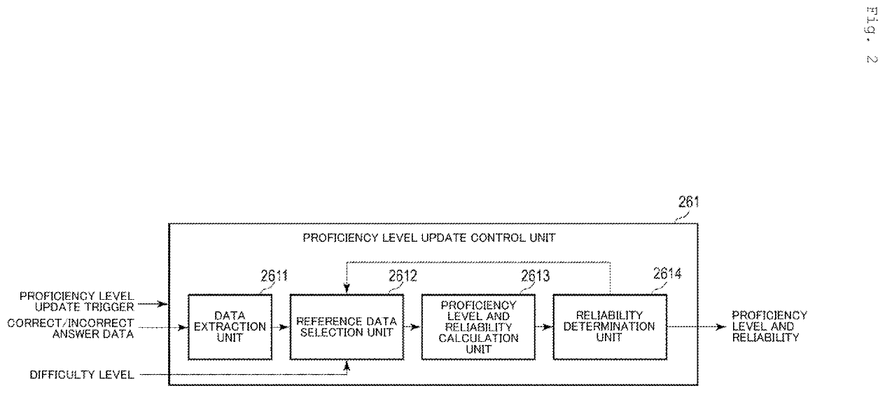

FIG. 2 illustrates a more detailed functional configuration of the proficiency level update control unit 261 included in the learning support device 1 configured as described above. The proficiency level update control unit 261 performs processing of calculating a proficiency level in response to the proficiency level update trigger and outputting the calculated proficiency level. The proficiency level update control unit 261 also includes a data extraction unit 2611, a reference data selection unit 2612, a proficiency level and reliability calculation unit 2613, and a reliability determination unit 2614.

The data extraction unit 2611 performs processing of extracting, based on user identification information (user ID) for specifying the update target, which is included as additional information in the proficiency level update trigger, pieces of correct/incorrect answer data that have the user ID from the correct/incorrect answer data storage unit 31.

The reference data selection unit 2612 performs processing of selecting reference data to be used for calculating the proficiency level from the extracted pieces of correct/incorrect answer data. The difficulty level and the reliability of the difficulty level stored in the parameter storage unit 32 are used to select the reference data. As a result of the selection, all data may be used.

The proficiency level and reliability calculation unit 2613 performs processing of calculating a proficiency level of the target user by using the reference data selected by the reference data selection unit 2612, and calculating a reliability related to the calculated proficiency level from the calculated proficiency level and a piece(s) of correct/incorrect answer data used for calculating the proficiency level.

The reliability determination unit 2614 performs processing of comparing the calculated reliability with a preset threshold value. When the calculated reliability is equal to or higher than the preset threshold value, the reliability determination unit 2614 outputs the calculated proficiency level together with the reliability in order to update the data stored in the parameter storage unit 32. When the calculated reliability is less than the preset threshold value, the reliability determination unit 2614 does not output the proficiency level. At this time, the reliability determination unit 2614 can instruct the reference data selection unit 2612 to change the reference data selection criterion.

(3) Configuration of Difficulty Level Update Control Unit

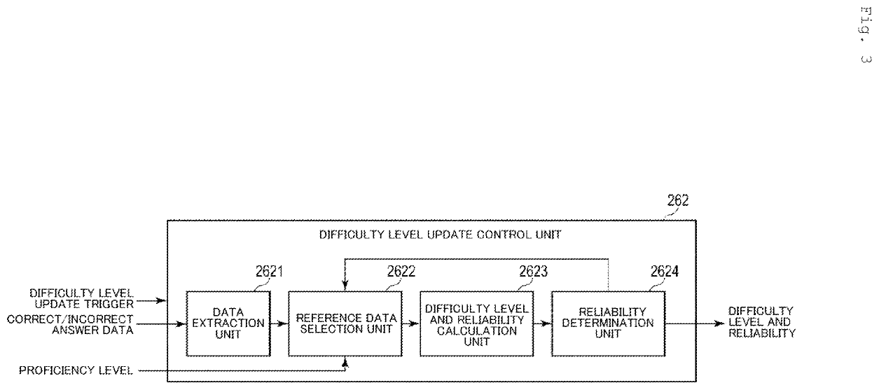

FIG. 3 illustrates a more detailed functional configuration of the difficulty level update control unit 262 included in the learning support device 1 configured as described above. The difficulty level update control unit 262 performs processing of calculating a difficulty level in response to the difficulty level update trigger and outputting the calculated difficulty level. The difficulty level update control unit 262 also includes a data extraction unit 2621, a reference data selection unit 2622, a difficulty level and reliability calculation unit 2623, and a reliability determination unit 2624.

The data extraction unit 2621 performs processing of extracting, based on item identification information (item ID) for specifying the update target, which is included as additional information in the difficulty level update trigger, pieces of correct/incorrect answer data that have the item ID from the correct/incorrect answer data storage unit 31.

The reference data selection unit 2622 performs processing of selecting reference data to be used for calculating the difficulty level from the extracted pieces of correct/incorrect answer data. The proficiency level and the reliability of the proficiency level stored in the parameter storage unit 32 are used to select the reference data. As a result of the selection, all data may be used.

The difficulty level and reliability calculation unit 2623 performs processing of calculating a difficulty level of the target item by using the reference data selected by the reference data selection unit 2622, and calculating a reliability related to the calculated difficulty level from the calculated difficulty level and a piece(s) of correct/incorrect answer data used for calculating the difficulty level.

The reliability determination unit 2624 performs processing of comparing the calculated reliability with a preset threshold value. When the calculated reliability is equal to or higher than the preset threshold value, the reliability determination unit 2624 outputs the calculated difficulty level together with the reliability in order to update the data stored in the parameter storage unit 32. When the calculated reliability is less than the preset threshold value, the reliability determination unit 2624 does not output the difficulty level. At this time, the reliability determination unit 2624 can instruct the reference data selection unit 2622 to change the reference data selection criterion.

(4) Configuration of Simultaneous Update Control Unit

FIG. 4 illustrates a more detailed functional configuration of the simultaneous update control unit 263 included in the learning support device 1 configured as described above. The simultaneous update control unit 263 performs processing of calculating a proficiency level and a difficulty level in response to the simultaneous update trigger and outputting the calculated proficiency level and difficulty level. The simultaneous update control unit 263 also includes a reference data selection unit 2631, a proficiency level and difficulty level and reliability calculation unit 2632, and a reliability determination unit 2633.

The reference data selection unit 2631 performs processing of selecting the reference data based on all pieces of correct/incorrect answer data stored in the correct/incorrect answer data storage unit 31, the proficiency level, the difficulty level, and their reliabilities which are stored in the parameter storage unit 32.

The proficiency level and difficulty level and reliability calculation unit 2632 uses the reference data selected by the reference data selection unit 2631 to calculate a new proficiency level, a new difficulty level, and their reliabilities.

The reliability determination unit 2633 performs processing of comparing the calculated reliability with a preset threshold value. When the calculated reliability is equal to or higher than the preset threshold value, the reliability determination unit 2633 outputs the calculated proficiency level and difficulty level together with their reliabilities in order to update the data stored in the parameter storage unit 32.

II. Operation

Next, processing operation performed by the learning support device 1 configured as described above will be described.

(1) Initial Parameter Calculation Processing

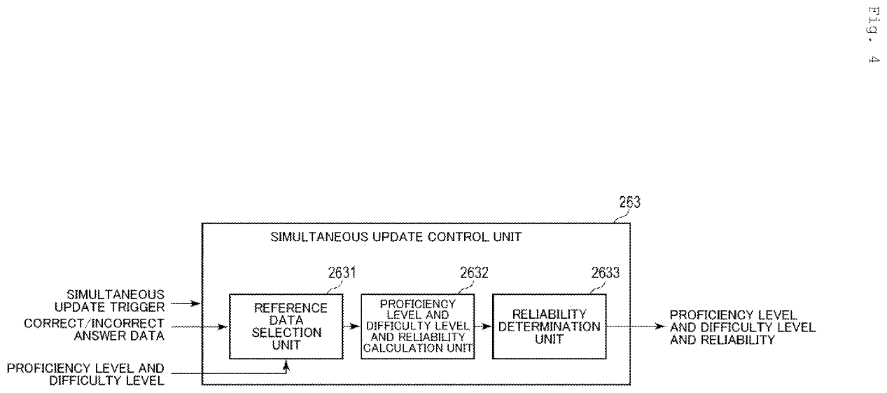

First, the learning support device 1 performs processing of acquiring initial data, calculating a proficiency level and a difficulty level from the initial data, and fixing a scale for difficulty level. The initial data is acquired via a learning system or the like according to the user's use of the service, and includes correct/incorrect answer data indicating whether answers from a plurality of users to a plurality of questions are each correct or incorrect. FIG. 5 is a flowchart illustrating a processing procedure for calculating a proficiency level and a difficulty level from such initial data and its processing content.

The learning support device 1 monitors the presence or absence of data input under the control of the control unit 20. In this state, when pieces of correct/incorrect answer data are collected via, for example, the learning system and the collected pieces of correct/incorrect answer data are transmitted to the learning support device 1, the learning support device 1 detects reception of this data and starts the following processing.

First, in step S101, the learning support device 1 acquires pieces of correct/incorrect answer data via the input/output interface unit 10 under the control of the correct/incorrect answer data acquisition unit 21, and stores the pieces of correct/incorrect answer data in the correct/incorrect answer data storage unit 31.

FIG. 10 illustrates an example of the correct/incorrect answer data table stored in the correct/incorrect answer data storage unit 31. In the example of FIG. 10, the correct/incorrect answer data table includes a column for correct/incorrect answer data IDs for identifying data records, a column for user IDs for identifying users, a column for item IDs for identifying questions, a column for correct/incorrect answer information indicating correct/incorrect answers (1 for correct, 0 for incorrect), and a column for date and time information.

After acquiring and storing the initial correct/incorrect answer data, the learning support device 1 receives an input of a parameter calculation instruction from, for example, a user, a system administrator, or the like, and performs subsequent parameter calculation processing.

In step S102, the learning support device 1 reads the pieces of correct/incorrect answer data accumulated from the correct/incorrect answer data storage unit 31 under the control of the parameter calculation unit 22, and calculates a proficiency level and a difficulty level by batch processing. To calculate the proficiency level and the difficulty level, the marginal maximum likelihood estimation method, item response theory using the Bayesian estimation method, or another method can be used.

In step S103, the learning support device 1 calculates the reliability of each of the calculated proficiency level and difficulty level under the control of the parameter calculation unit 22. As an index of the reliability, the amount of test information or the number of answers can be used. The amount of test information for the proficiency level and the difficulty level can be calculated using the following Equations 3 and 4.

$$\begin{matrix}( Equation 3 ) & \\ I ( {θ}_{j} ) = {\sum }_{i}^{I} {D}^{2} {P}_{ij} ( 1 - {P}_{ij} ) & [ Formula 3 ] \\ ( Equation 4 ) & \\ I ( {b}_{i} ) = {\sum }_{j}^{J} {D}^{2} {P}_{ij} ( 1 - {P}_{ij} ) , & [ Formula 4 ]\end{matrix}$$

where C is an arbitrary constant, and in the present embodiment, D=1.7.

Note that, as an index of the reliability, an index such as the Monte Carlo method can be used instead of an amount of test information. In the case of the Monte Carlo method, the trial of randomly extracting a piece of correct/incorrect answer data corresponding to a certain item is repeated N times, difficulty levels are calculated from the resulting samples, and the reciprocal of a variance of the distribution of the calculated difficulty levels can be calculated as the reliability level. Similarly, for the proficiency level, the trial of randomly extracting a piece of correct/incorrect answer data corresponding to a certain user is repeated N times, proficiency levels are calculated from the resulting samples, and the reciprocal of a variance of the distribution of the calculated proficiency levels can be calculated as the reliability level.

Next, in step S104, the learning support device 1 stores the proficiency level, the difficulty level, and their reliabilities which are calculated in steps S102 and S103 in the parameter storage unit 32 under the control of the parameter calculation unit 22.

Note that if a difficulty level is set in advance before the above processing is performed, that difficulty level can be used. In this case, using a method similar to proficiency level update processing which will be described below, proficiency levels are calculated using the preset difficulty level, the reliability of each of the calculated proficiency levels is calculated, and the proficiency level, the difficulty level, and the reliability are stored in the parameter storage unit 32.

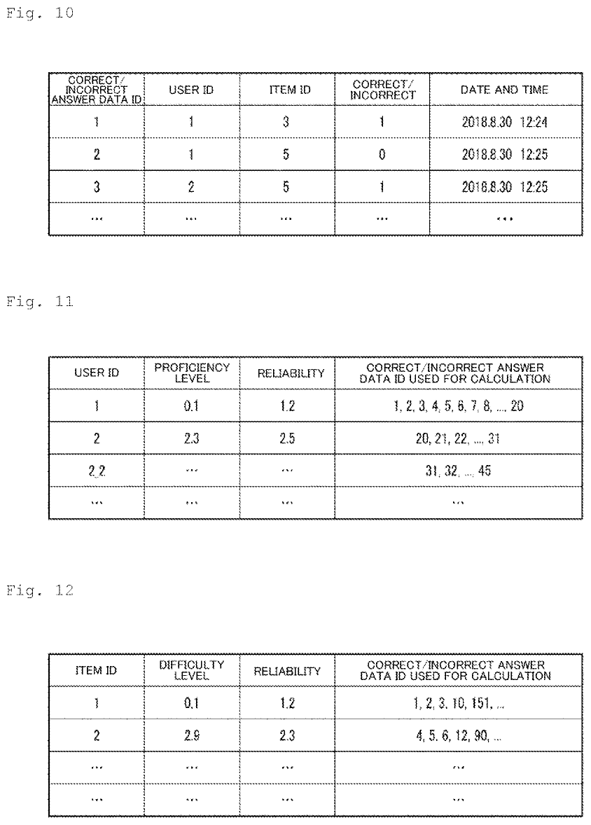

FIG. 11 illustrates an example of the proficiency level table that stores the proficiency level and its reliability, which is stored in the parameter storage unit 32. In the example of FIG. 11, the proficiency level and its reliability calculated for each user, and the correct/incorrect answer data IDs used for calculating the proficiency level are stored in association with the user ID for identifying the user. Note that the user ID “2-2” here means the second ID for the same user as the user ID “2”. This will be further described in the following (3-1-2) regarding the proficiency level updating processing for a long-term user.

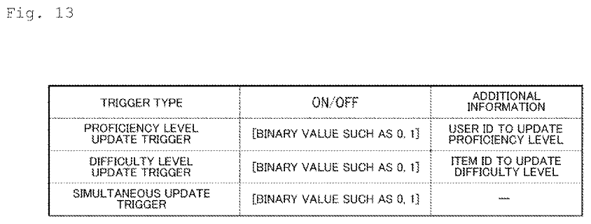

Similarly, FIG. 12 illustrates an example of the difficulty level table that stores the difficulty level and its reliability, which is stored in the parameter storage unit 32. In the example of FIG. 12, the difficulty level and its reliability calculated for each item, and the correct/incorrect answer data IDs used for calculating the difficulty level are stored in association with the item ID for identifying the item.

(2) Update Trigger Generation and Output Processing

Next, processing in which the learning support device 1 determines whether or not a parameter needs to be updated and outputs an update trigger will be described.

Under the control of the update trigger determination unit 24, the learning support device 1 refers to the data in the correct/incorrect answer data storage unit 31 and the parameter storage unit 32 to determine whether or not a parameter needs to be updated, for example, at regular intervals, and then writes the determination result in the trigger table in the trigger table storage unit 33.

FIG. 13 illustrates an example of the update trigger table that defines update triggers, which is stored in the trigger table storage unit 33. The update triggers include three types of update triggers: a proficiency level update trigger, a difficulty level update trigger, and a simultaneous update trigger. When the update trigger determination unit 24 determines that the parameter needs to be updated, the update trigger determination unit 24 enters 1 in the ON/OFF column of the update trigger table and writes additional information as necessary. When the update is not necessary, 0 is entered in the ON/OFF column and the additional information is deleted.

Further, the learning support device 1 monitors the update trigger table stored in the trigger table storage unit 33 under the control of the trigger output control unit 25. When the proficiency level update trigger is turned ON in the update trigger table, the trigger output control unit 25 generates a proficiency level update trigger, and notifies the update control unit 26 of the user ID for which the proficiency level update is to be performed together with the proficiency level update trigger. When the difficulty level update trigger is turned ON, the trigger output control unit 25 generates a difficulty level update trigger, and notifies the update control unit 26 of the item ID for which the difficulty level update is to be performed together with the difficulty level update trigger. When the simultaneous update trigger is ON, the trigger output control unit 25 generates a simultaneous update trigger, and notifies the update control unit 26 of it. Note that the simultaneous update trigger does not require the update processing for the proficiency level and the difficulty level at the same timing, but refers to a trigger for instructing to update both the proficiency level and the difficulty level within a fixed time.

Hereinafter, determination of whether or not a parameter needs to be updated in the update trigger determination unit 24 will be further described for each of the three types of update triggers.

(2-1) Proficiency Level Update Trigger

There are many possible examples of the method of determining whether or not a proficiency level parameter needs to be updated in the update trigger determination unit 24. Some of them will be described below.

(2-1-1) Case Where a New User is Generated.

When it is determined that a new user is generated, the update trigger determination unit 24 determines that the proficiency level of the new user needs to be updated.

For example, the update trigger determination unit 24 determines whether or not there are N1 or more pieces of user ID data that are not stored in the proficiency level table of the parameter storage unit 32, in the correct/incorrect answer data storage unit 31. When it is determined that there are N1 or more pieces, the update trigger determination unit 24 determines that the proficiency level of the new user needs to be updated, writes 1 in the ON/OFF column for the proficiency level update trigger of the trigger table, and writes the user ID in the additional information column. Note that N1 is an arbitrary integer of 1 or more.

(2-1-2) Case Where Data of an Existing User Increases

When it is determined that the data of an existing user increases, the update trigger determination unit 24 determines that the proficiency level of the user needs to be updated.

For example, the update trigger determination unit 24 determines whether or not there are N2 or more pieces of correct/incorrect answer data that are not written in the correct/incorrect answer data ID column used for calculating the proficiency level table in the parameter storage unit 32 for the user ID stored in the proficiency level table in the parameter storage unit 32, in the correct/incorrect answer data storage unit 31. When it is determined that there are N2 or more pieces, the update trigger determination unit 24 determines that the data of the existing user increases and thus the proficiency level of the new user needs to be updated, writes 1 in the ON/OFF column for the proficiency level update trigger of the trigger table, and writes the user ID in the additional information column. Note that N2 is an arbitrary integer of 1 or more and is preferably the same as N1, but may be different.

(2-1-3) Case Where an Update Trigger Input is Received

The update trigger determination unit 24 determines that the proficiency level needs to be updated in response to receiving the input for instructing to update.

For example, when a proficiency level update instruction from inside or outside is received, which is generated according to a preset schedule or is input through an input unit (not illustrated) when the user wants to recalculate his/her proficiency level, the update trigger determination unit 24 determines that the proficiency level of the user needs to be updated. Then, the update trigger determination unit 24 writes 1 in the ON/OFF column for the proficiency level update trigger in the trigger table, and writes the user ID in the additional information column.

(2-1-4) Case Where the Reliability is Low

When it is determined that the reliability of the stored data is low, the update trigger determination unit 24 determines that the proficiency level of the corresponding user needs to be updated.

For example, the update trigger determination unit 24 determines that the proficiency level needs to be updated when the following two conditions are both satisfied. The first condition is that the reliability of the proficiency level stored in the proficiency level table stored in the parameter storage unit 32 is lower than a preset threshold value T1. The second condition is that the correct/incorrect answer data table stored in the correct/incorrect answer data storage unit 31 includes a piece of correct/incorrect answer data which is not written as the correct/incorrect answer data ID used for calculating the proficiency level in the proficiency level table. Then, the update trigger determination unit 24 writes 1 in the ON/OFF column for the proficiency level update trigger in the update trigger table, and writes the user ID of the corresponding user in the additional information column.

(2-2) Difficulty Level Update Trigger

There are many possible examples of the method of determining whether or not a difficulty level parameter needs to be updated in the update trigger determination unit 24. Some of them will be described below.

(2-2-1) Case Where a New Item is Generated

When it is determined that a new item is generated, the update trigger determination unit 24 determines that the difficulty level of the new item needs to be updated.

For example, the update trigger determination unit 24 determines whether or not there are N3 or more pieces of item ID data that are not stored in the difficulty level table of the parameter storage unit 32, in the correct/incorrect answer data storage unit 31. When it is determined that there are N3 or more pieces, the update trigger determination unit 24 determines that the difficulty level of the new item needs to be updated, writes 1 in the ON/OFF column for the difficulty level update trigger of the trigger table, and writes the item ID in the additional information column. Note that N3 is an arbitrary integer of 1 or more.

(2-2-2) Case Where Data of an Existing Item Increases

When it is determined that the data of an existing item increases, the update trigger determination unit 24 determines that the difficulty level of the item needs to be updated.

For example, the update trigger determination unit 24 determines whether or not there are N4 or more pieces of correct/incorrect answer data that are not written in the correct/incorrect answer data ID column used for calculating the difficulty level table in the parameter storage unit 32 for the item ID stored in the difficulty level table in the parameter storage unit 32, in the correct/incorrect answer data storage unit 31. When it is determined that there are N4 or more pieces, the update trigger determination unit 24 determines that the data of the existing item increases and thus the difficulty level of the new item needs to be updated, writes 1 in the ON/OFF column for the difficulty level update trigger of the trigger table, and writes the item ID in the additional information column. Note that N4 is an arbitrary integer of 1 or more and is preferably the same as N3, but may be different.

(2-2-3) Case Where an Update Trigger Input is Received

The update trigger determination unit 24 determines that the difficulty level needs to be updated in response to receiving the input for instructing to update.

For example, when a difficulty level update instruction from inside or outside is received, which is generated according to a preset schedule or is input through an input unit (not illustrated) when the system administrator wants to recalculate the difficulty level of a specific item, the update trigger determination unit 24 determines that the difficulty level of the item needs to be updated. Then, the update trigger determination unit 24 writes 1 in the ON/OFF column for the difficulty level update trigger in the trigger table, and writes the item ID in the additional information column.

(2-2-4) Case Where the Reliability is Low

When it is determined that the reliability of the stored data is low, the update trigger determination unit 24 determines that the difficulty level of the corresponding item needs to be updated.

For example, the update trigger determination unit 24 determines that the difficulty level needs to be updated when the following two conditions are both satisfied. The first condition is that the reliability of the difficulty level stored in the difficulty level table stored in the parameter storage unit 32 is lower than a preset threshold value T2. The second condition is that the correct/incorrect answer data table stored in the correct/incorrect answer data storage unit 31 includes a piece of correct/incorrect answer data which is not written as the correct/incorrect answer data ID used for calculating the difficulty level in the difficulty level table. Then, the update trigger determination unit 24 writes 1 in the ON/OFF column for the difficulty level update trigger in the update trigger table, and writes the item ID in the additional information column.

(2-3) Simultaneous Update Trigger

There are many possible examples of the method of determining whether or not a proficiency level and a difficulty level need to be updated in the update trigger determination unit 24. Some of them will be described below.

(2-3-1) Case Where the Number of Pieces of Correct/Incorrect Answer Data Increases

The update trigger determination unit 24 determines that the proficiency level and the difficulty level need to be updated each time the cumulative number of acquired pieces of correct/incorrect answer data exceeds a certain value.

For example, when it is determined that the pieces of correct/incorrect answer data stored in the correct/incorrect answer data storage unit 31 reaches a multiple of M, the update trigger determination unit 24 determines that the proficiency level and the difficulty level need to be updated, and writes 1 in the ON/OFF column for the simultaneous update trigger. Note that M is an arbitrary integer and is preferably a large unit such as 10,000 or 100,000.

(2-3-2) Case Where an Update Trigger Input is Received

The update trigger determination unit 24 determines that the proficiency level and the difficulty level need to be updated in response to receiving the input for instructing to update.

For example, when the update trigger determination unit 24 receives an instruction for simultaneous update from inside and outside, such as when the system administrator wants to update the scale for difficulty level or when the update is performed according to a yearly or monthly schedule, the update trigger determination unit 24 writes 1 in the ON/OFF column for the simultaneous update trigger of the update trigger table.

(2-3-3) Case Where the Number of Items/Users with a Low Reliability Increases

When it is determined that the number of pieces of data with a low reliability increases, the update trigger determination unit 24 determines that the proficiency level and the difficulty level need to be updated.

For example, the update trigger determination unit 24 determines that the proficiency level and the difficulty level need to be updated in the following case, and writes 1 in the ON/OFF column for the difficulty level and proficiency level trigger. “The following case” is a case where an average value of the reliabilities of the difficulty levels stored in the difficulty level table stored in the parameter storage unit 32 or an average value of the reliabilities of the proficiency levels stored in the proficiency level table is below a predetermined threshold value L1. Alternatively, “the following case” is a case where a ratio of data for which an average value of the reliabilities of the difficulty levels or an average value of the reliabilities of the proficiency levels is below a predetermined threshold value L2 to the entire data increases.

(2-3-4) Case Where an Estimated Probability of Correct Answer Does Not Match the Correct/Incorrect Answer Data

When it is determined that a difference between the probability of correct answer obtained based on the calculated parameters and the probability of correct answer obtained from the actual correct/incorrect answer data is large, the update trigger determination unit 24 determines that the proficiency level and the difficulty level need to be updated.

For example, the update trigger determination unit 24 can obtain the probability of a user j answering an item i correctly by substituting the proficiency level of each user and the difficulty level of each item stored in the parameter storage unit 32 into Equation 1. In a case where it is estimated that the answer is correct for a probability of 0.5 or more and incorrect for a probability of less than 0.5, when a coincidence rate between the answers and the correct/incorrect answer data stored in the correct/incorrect answer data storage unit 31 is below a preset threshold value R, the update trigger determination unit 24 determines that the proficiency level and the difficulty level need to be updated. Then, the update trigger determination unit 24 writes 1 in the ON/OFF column for the difficulty level and proficiency level trigger. Note that the threshold value R is a decimal number less than 1, such as 0.7.

(3) Parameter Update Processing

Next, some possible examples of processing of each unit of the update control unit 26 in response to receiving an update trigger from the trigger output control unit 25 will be described.

(3-1) Update of a Proficiency Level

(3-1-1) Update of the Proficiency Level of a New User or an Existing User Who Has New Correct/Incorrect Answer Data

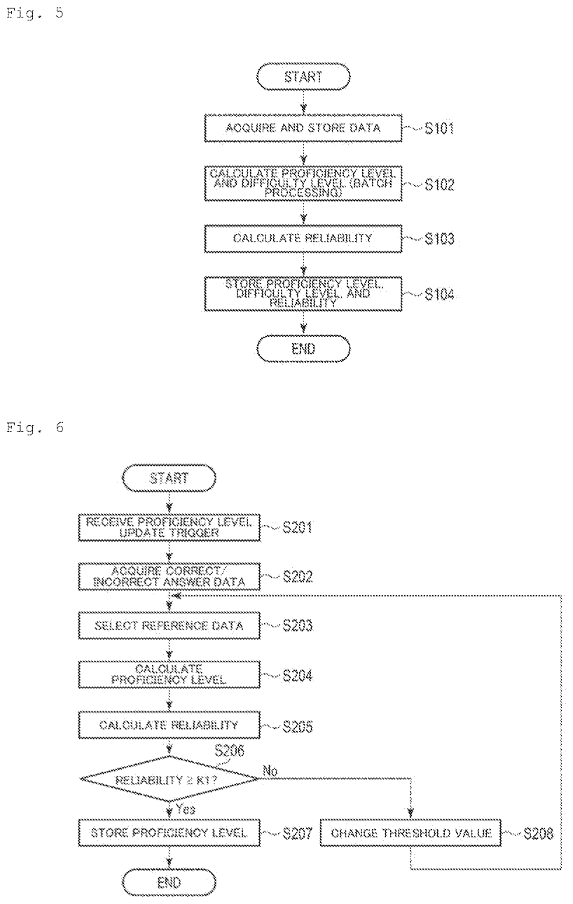

FIG. 6 is a flowchart illustrating processing procedure of updating the proficiency level of a new user or an existing user who has new correct/incorrect answer data, executed by the proficiency level update control unit 261, and its processing content.

First, in step S201, the proficiency level update control unit 261 receives the proficiency level update trigger output from the trigger output control unit 25, and starts the following processing.

In step S202, the proficiency level update control unit 261 extracts, from the correct/incorrect answer data storage unit 31, the piece(s) of correct/incorrect answer data associated with the user ID notified together with the proficiency level update trigger, under the control of the data extraction unit 2611.

In step S203, the proficiency level update control unit 261 selects reference data to be used for updating the proficiency level from among the pieces of correct/incorrect answer data extracted in step S202, under the control of the reference data selection unit 2612. Upon the selection, the reference data selection unit 2612 selects an item having a higher reliability than a preset threshold value T3 serving as a reference from among difficulty parameters stored on a per-item basis in the parameter storage unit 32.

In step S204, the proficiency level update control unit 261 uses the item selected in step S203 to calculate a proficiency level, under the control of the proficiency level and reliability calculation unit 2613. To calculate the proficiency level, the difficulty level of the reference data may be substituted into Equation 2 so that the maximum. likelihood estimation method or other methods can be used.

In step S205, the proficiency level update control unit 261 calculates a reliability of the proficiency level calculated in step S204, under the control of the proficiency level and reliability calculation unit 2613. As an index of the reliability, the amount of test information and the reliability using the Monte Carlo method, which are described above, can be used.

Then, in step S206, the proficiency level update control unit 261 determines the level of the reliability of the proficiency level calculated in step S204 based on the reliability calculated in step S205, under the control of the reliability determination unit 2614. Here, if the calculated reliability is equal to or higher than a preset threshold value K1, the processing proceeds to step S207.

In step S207, the proficiency level update control unit 261 outputs the calculated proficiency level and reliability to the parameter storage unit 32 to store them therein.

On the other hand, in step S206, if the calculated reliability is lower than the threshold value K1, the processing proceeds to step S208. At this time, the reliability determination unit 2614 outputs, to the reference data selection unit 2612, an instruction to change the threshold value T3 used for selecting the reference data and to reselect reference data.

In step S208, the proficiency level update control unit 261 performs processing of reducing the threshold value T3 used for selecting the reference data to T3₁ (T3>T3₁) in order to increase the reference data, under the control of the reference data selection unit 2612.

Subsequently, the processing returns to step S203, and then the proficiency level update control unit 261 uses the threshold value T3₁, which has been changed, to reselect reference data, under the control of the reference data selection unit 2612.

Next, the proficiency level update control unit 261 uses the reselected reference data to perform steps S204 to S206 again to determine the reliability of the calculated new proficiency level. In step S206, the change of the threshold value T3ₓ and the calculation of the parameter are repeated until the newly calculated reliability becomes equal to or higher than the threshold value K1. In step S206, if the reliability is still lower than K1 and the threshold value T3ₓ used for selecting the reference data becomes T3ₘᵢₙ which is preset as the minimum value of the threshold value, the proficiency level update control unit 261 can end the processing without updating the proficiency level.

(3-1-2) Update the Proficiency Level of a Long-Term User

Even when a new piece of correct/incorrect answer data is obtained for an existing user, especially for a long-term user, the same processing as (3-1-1) can be performed. However, if the user has been using the service for a long period of time, or if the period of time is not so long but the user seems to get proficiency rapidly, it is difficult to express the user's characteristics with a single proficiency level, and it is expected that the degree of conformity between the model and actual data decreases. In order to avoid such a discrepancy between the model and the data, the pieces of data of the same user can be divided so as to be regarded as those of a plurality of users having different proficiency levels.

FIG. 7 is a flowchart illustrating processing procedure of updating the proficiency level of a user whose proficiency level is significantly changed, executed by the proficiency level update control unit 261, and its processing content. This processing may be automatically performed when pieces of correct/incorrect answer data having a specific user ID are accumulated for more than a certain period of time, or may be performed in response to an instruction input from a user or an operator.

First, in step S301, the proficiency level update control unit 261 receives the proficiency level update trigger output from the trigger output control unit 25, and starts the following processing.

In step S302, the proficiency level update control unit 261 extracts, from the correct/incorrect answer data storage unit 31, the piece(s) of correct/incorrect answer data associated with the user ID notified together with the proficiency level update trigger, under the control of the data extraction unit 2611. At this time, the data extraction unit 2611 can refer to the data ID used for calculating the proficiency level table stored in the parameter storage unit 32 to obtain only pieces of correct/correct data that have not been used for calculating the currently stored proficiency level.

In step S303, the proficiency level update control unit 261 selects reference data to be used for updating the proficiency level from among the pieces of correct/incorrect answer data extracted in step S302, under the control of the reference data selection unit 2612. Upon the selection, the reference data selection unit 2612 selects an item having a higher reliability than a preset threshold value T4 serving as a reference from among difficulty parameters stored on a per-item basis in the parameter storage unit 32. Note that T4 is preferably the same as T3, but may have a different value.

In step S304, the proficiency level update control unit 261 uses the item selected in step S303 to calculate a proficiency level, under the control of the proficiency level and reliability calculation unit 2613. To calculate the proficiency level, a method similar to (3-1-1) can be used.

In step S305, the proficiency level update control unit 261 calculates a reliability of the proficiency level calculated in step S304, under the control of the proficiency level and reliability calculation unit 2613. Also to calculate the reliability, a method similar to (3-1-1) can be used.

In step S306, the proficiency level update control unit 261 determines the level of the reliability of the proficiency level calculated in step S304 based on the reliability calculated in step S305, under the control of the reliability determination unit 2614. Here, if the calculated reliability is equal to or higher than a preset threshold value K2, the processing proceeds to step S307.

In step S307, the proficiency level update control unit 261 refers to the parameter storage unit 32 to calculate a difference between a previously calculated proficiency level and the proficiency level newly calculated in step S304.

In step S308, if the difference from the previous proficiency level is equal to or higher than a preset threshold value Q, the proficiency level update control unit 261 determines that the proficiency level has changed significantly, and then the processing proceeds to step S309.

In step S309, the proficiency level update control unit 261 determines that the proficiency levels calculated in step S304 is actually the data of the same user but is of another user having a different proficiency level, assigns a new user ID to the proficiency level, and stores it in the parameter storage unit 32. At this time, the proficiency level update control unit 261 deletes the piece(s) of correct/incorrect answer data used in step S302 from the correct/incorrect answer data storage unit 31, reassigns the new user ID to the remaining pieces, and stores them. For example, as illustrated in FIG. 11, by assigning a new user ID “2_2”, the remaining pieces can be distinguished from those for the original user ID “2”. Note that K2 is preferably the same value as K1, but may use a different value.

On the other hand, in step S308, if the difference from the previous proficiency level is lower than the preset threshold value Q, the processing proceeds to step S311.

In step S311, the proficiency level update control unit 261 recalculates a proficiency level by using all the data of the corresponding user stored in the correct/incorrect answer data storage unit 31.

Next, in step S312, the proficiency level update control unit 261 updates the recalculated proficiency level as a new proficiency level of the existing user, and stores it in the parameter storage unit 32.

On the other hand, in step S305, if the calculated reliability is lower than the threshold value K2, the processing proceeds to step S310. At this time, the reliability determination unit 2614 outputs, to the reference data selection unit 2612, an instruction to change the threshold value T4 used for selecting the reference data and to reselect reference data.

In step S310, the proficiency level update control unit 261 performs processing of reducing the threshold value T4 used for selecting the reference data to T4₁ (T4>T4₁) in order to increase the reference data, under the control of the reference data selection unit 2612.

Subsequently, the processing returns to step S303, and then the proficiency level update control unit 261 uses the threshold value T4₁, which has been changed, to reselect reference data, under the control of the reference data selection unit 2612.

Next, the proficiency level update control unit 261 uses the reselected reference data to perform steps S304 to S306 again to determine the reliability of the calculated new proficiency level. In step S306, the change of the threshold value T4ₓ and the calculation of the parameter are repeated until the newly calculated reliability becomes equal to or higher than the threshold value K2. In step S306, if the reliability is still lower than K2 and the threshold value T4ₓ used for selecting the reference data becomes T₄min which is preset as the minimum value of the threshold value, the proficiency level update control unit 261 can end the processing without updating the proficiency level.

(3-1-3) Regular Update of the Proficiency Level for a Long-Term User

As another embodiment, a method can be used in which the correct/incorrect answer data is divided by a specific period L (e.g., one week, one month, three months, etc.), the resulting piece is assigned a new user ID, and a proficiency level for each period L is calculated.

(3-2) Update of the Difficulty Level

(3-2-1) Update of the Difficulty Level of a New Item or an Existing Item That Has New Correct/Incorrect Answer Data

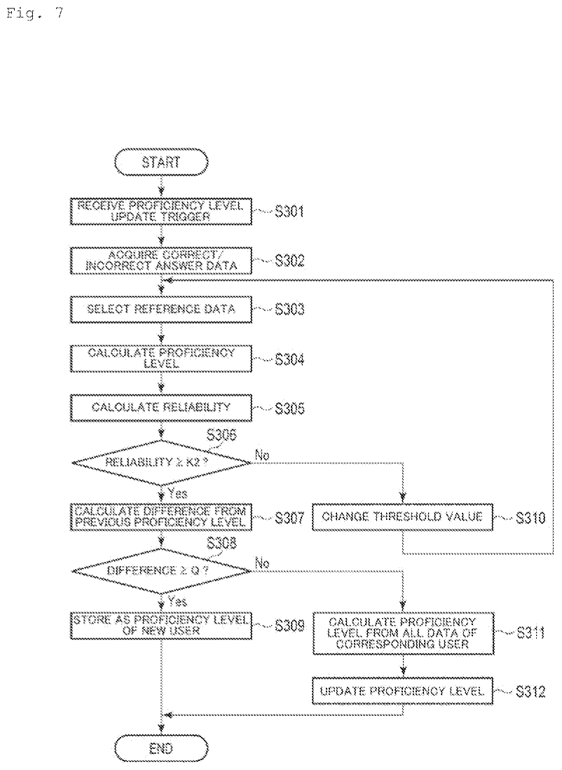

FIG. 8 is a flowchart illustrating processing procedure of calculating and updating a difficulty level of a new item or an item that has new correct/incorrect answer data on the same scale as the scale for difficulty level of the item whose difficulty level has already been calculated, executed by the difficulty level update control unit 262, and its processing content.

First, in step S401, the difficulty level update control unit 262 receives the difficulty level update trigger output from the trigger output control unit 25, and starts the following processing.

In step S402, the difficulty level update control unit 262 extracts, from the correct/incorrect answer data storage unit 31, the piece (s) of correct/incorrect answer data associated with the item ID notified together with the difficulty level update trigger, under the control of the data extraction unit 2621.

In step S403, the difficulty level update control unit 262 selects reference data to be used for updating the difficulty level from among the pieces of correct/incorrect answer data extracted in step S402, under the control of the reference data selection unit 2622. Upon the selection, the reference data selection unit 2622 sets to reference data the data of a user of whom the reliability of the proficiency level stored in the parameter storage unit 32 is higher than a preset threshold value 15 among users who have data for the new item.

In step S404, the difficulty level update control unit 262 calculates a difficulty level of the corresponding item based on the data selected in step S403, under the control of the difficulty level and reliability calculation unit 2623. In this step, for example, the proficiency level of the reference data can be substituted into Equation 2 to obtain the difficulty level by means of a method such as the maximum likelihood estimation.

In step S405, the difficulty level update control unit 262 uses a method such as the amount of test information to calculate a reliability of the difficulty level calculated in step S404, under the control of the difficulty level and reliability calculation unit 2623.

Subsequently, in step S406, the difficulty level update control unit 262 compares the reliability calculated in step S405 with a preset threshold value K3, under the control of the reliability determination unit 2624, and if the reliability is K3 or more, the processing proceeds to step S407.

In step S407, the difficulty level update control unit 262 outputs the calculated difficulty level and reliability to the parameter storage unit 32 to store them therein.

On the other hand, in step S406, if the calculated reliability is lower than the threshold value K3, the processing proceeds to step S408. At this time, the reliability determination unit 2624 outputs, to the reference data selection unit 2622, an instruction to change the threshold value T5 used for selecting the reference data and to reselect reference data.

In step S408, the difficulty level update control unit 262 performs processing of reducing the threshold value T5 used for selecting the reference data to T5₁ (T5>T5₁) in order to increase the reference data, under the control of the reference data selection unit 2622.

Subsequently, the processing returns to step S403, and then the difficulty level update control unit 262 uses the threshold value T5₁, which has been changed, to reselect reference data, under the control of the reference data selection unit 2622.

Next, the difficulty level update control unit 262 uses the reselected reference data to perform steps S404 to S406 again to determine the reliability of the calculated new proficiency level. In step S406, the change of the threshold value T5ₓ and the calculation of the parameter are repeated until the newly calculated reliability becomes equal to or higher than the threshold value K3. In step S406, if the reliability is still lower than K3 and the threshold value T5ₓ used for selecting the reference data becomes T5ₘᵢₙ, which is preset as the minimum value of the threshold value, the difficulty level update control unit 262 can end the processing without updating the difficulty level.

(3-3) Simultaneous Update of the Proficiency Level and Difficulty Level

In the conventional method, a difficulty level is calculated from a small amount of initial data, and the scale for difficulty level is fixed and continues to be used. Therefore, when a large amount of data is accumulated, especially when the user population changes, the model may have a poor fit to the entire data. It is expected that using item response theory for new data to only re-estimate the proficiency level and the difficulty level results in a large difference from the previous scale for difficulty level, and causes the user to feel uncomfortable when compared with the previous parameters.

Therefore, in the learning support device 1 according to the embodiment, the simultaneous update control unit 263 performs processing of updating the difficulty level while reducing discomfort of the user.

When the simultaneous update control unit 263 receives the simultaneous update trigger output from the trigger output control unit 25, the simultaneous update control unit 263 starts update control processing for the proficiency level and the difficulty level. At this time, the simultaneous update control unit 263 calculates a new proficiency level and a new difficulty level with reference to the data in the correct/incorrect answer data storage unit 31 and the parameter storage unit 32, and stores the calculation results in the parameter storage unit 32. Note that as described above, the simultaneous update is not necessarily limited to processing of updating the proficiency level and the difficulty level at the same timing, but includes processing of updating the proficiency level and the difficulty level within a fixed time.

Many examples of the specific processing performed by the simultaneous update control unit 263 are possible. Some of them will be described below.

(3-3-1) Update Using Update Rate α

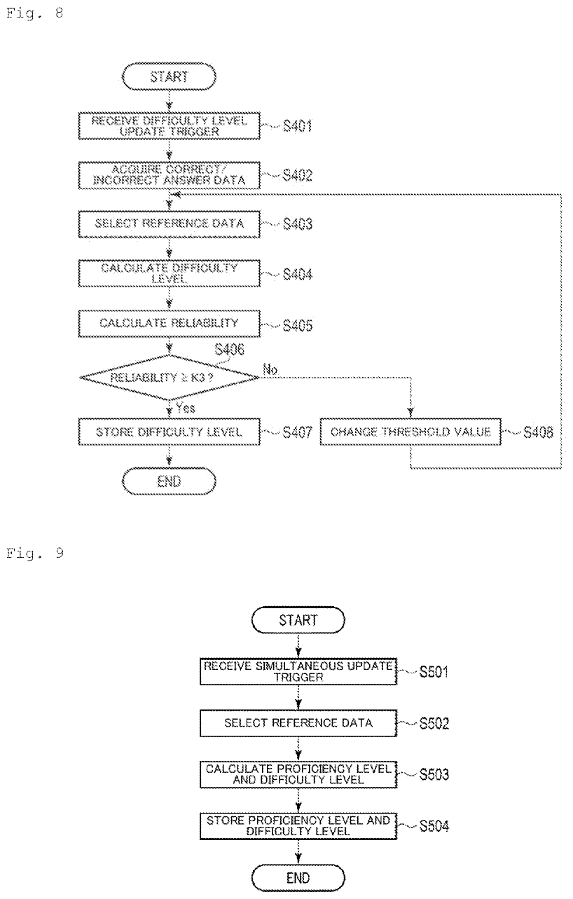

FIG. 9 illustrates an example of a processing flow of simultaneously updating the difficulty level and the proficiency level, executed by the simultaneous update control unit 263.

First, in step S501, the simultaneous update control unit 263 receives the simultaneous update trigger output from the trigger output control unit 25, and starts the following processing.

In step S502, the simultaneous update control unit 263 selects reference data under the control of the reference data selection unit 2631. Upon the selection, the parameter storage unit 32 is referred to, only the difficulty level having a reliability of a threshold value T6 or more and the proficiency level having a reliability of a threshold value T7 or more are selected, and pieces of correct/incorrect answer data related to the corresponding item and user are extracted from the correct/incorrect answer data storage unit. 31. T6 is preferably the same as T3 used in (3-1-1), but may be a different value. Further, T7 is preferably the same as T5 used in (3-2-1), but may be a different value.

Next, in step S503, the simultaneous update control unit 263 calculates a proficiency level and a difficulty level and their reliabilities by using the selected reference data under the control of the proficiency level and difficulty level and reliability calculation unit 2632. There are many possible methods of calculating the parameters. For example, it is possible to adopt a method of using the marginal maximum likelihood estimation method or the like with all correct/incorrect answer data for the reference user, as a method of calculating the parameters. Alternatively, it is possible to adopt, for example, a method in which the difficulty level of the reference data is substituted into Equation 2 to calculate a proficiency level by using the maximum likelihood estimation method or the like, and the resulting proficiency level is substituted into Equation 2 to calculate a difficulty level by using the maximum likelihood estimation method or the like, and these calculations are repeated until the levels converge.

In step S504, the simultaneous update control unit 263 determines in the reliability determination unit 2633 that the reliabilities of the new proficiency level and difficulty level thus calculated are equal to or higher than a preset threshold value, and then stores the new proficiency level and difficulty level in the parameter storage unit 32.

Here, when the new proficiency level and difficulty level thus calculated are set as:

[ [symbol] ]*, [ [symbol] ]*

, the simultaneous update control unit 263 can update the proficiency level and the difficulty level according to the following Equation 5 and Equation 6 using an update rate α.

[Formula 6]

[ [symbol] ]ₛ₊₁=(1−α)[ [symbol] ]ₛ+α[ [symbol] ]* (Equation 5)

[Formula 7]

[ [symbol] ₗ]ₛ₊₁=(1−α)[ [symbol] ]ₛ+α[ [symbol] ]* (Equation 6)

, where s is an integer representing the number of updates. When the difficulty level and the proficiency level are updated by the simultaneous update control unit 263 and are then stored in the parameter storage unit 32 in step S504, the value of s can be incremented by 1.

For a user who is not the reference user, the proficiency level can be obtained by using the same method as the proficiency level calculation for new user data described in (3-1-1).

Further, if a discrepancy with the previous scale for difficulty level does not cause any problem in form of the service, setting α to 1 makes it possible to use only the newly calculated parameters.

(3-3-2) Update as Time Series Data

As a second example of updating the difficulty level and the proficiency level at once, each parameter can be treated as time-series data, for example, when the difficulty level and the proficiency level are calculated regularly. At this time, in order to prevent the user from feeling uncomfortable with the change in the scale for difficulty level, the scale for difficulty level can be gently changed by using a method such as for moving average.

Suppose that the proficiency level and the difficulty level calculated from the pieces of data accumulated at a time t are set as:

[θⱼ]ₜ, [bᵢ]ₜ [Formula 8]

Here, when the parameters to be stored in the parameter storage unit 32 and to be used for feedback to the user are set as:

[ [symbol] ]ₜ, [ [symbol] ]ₜ [Formula 9]

, these parameters are calculated by the following Equation 7 and Equation 8.

$$\begin{matrix}( Equation 7 ) & \\ {[ ]}_{t} = {[ ]}_{t - 1} - \frac{{[ {θ}_{j} ]}_{t - m + 1}}{m} + \frac{{[ {θ}_{j} ]}_{t}}{m} & [ Formula 10 ] \\ ( Equation 8 ) & \\ {[ ]}_{t} = {[ ]}_{t - 1} - \frac{{[ {b}_{i} ]}_{t - m + 1}}{m} + \frac{{[ {b}_{i} ]}_{t}}{m} & [ Formula 11 ]\end{matrix}$$

The above calculations are each called the simple moving average, and m indicates the number of time points used for the moving average. In addition to or instead of the simple moving average, a commonly used moving average method can be adopted such as weighted moving average, exponential moving average, modified moving average, triangular moving average, sine weighted moving average, cumulative moving average, or KZ filter.

III. Advantageous Effects

As described in detail above, in the learning support device 1 according to the embodiment, pieces of correct/incorrect answer data are acquired by the correct/incorrect answer data acquisition unit 21 and are stored in the correct/incorrect answer data storage unit 31. Then, various parameters are calculated based on the pieces of correct/incorrect answer data by the parameter calculation unit 22 and are stores in the parameter storage unit 32. The stored parameters are read and output by the parameter output control unit to be presented to a user, a system administrator, or the like at any time, for example, in response to a request from an external application.

Here, the update trigger determination unit 24 and the trigger output control unit 25 determines whether or not the parameters are to be updated by monitoring the data stored in the correct/incorrect answer data storage unit 31 and the parameter storage unit 32, or by receiving an update instruction from inside or outside to update the parameters, and generates a necessary update trigger to be notified to the update control unit 26. When receiving the update trigger, the update control unit 26 performs update control processing for the instructed parameter. At that time, the update control unit 26 extracts only highly reliable data from the data stored in the correct/incorrect answer data storage unit 31 and the parameter storage unit 32, and uses the extracted data as reference data to recalculate a parameter. Furthermore, the data stored in the parameter storage unit 32 is updated only when the reliability of the recalculated parameter is higher than a certain value.

As described above, the problem of a lowered reliability of the proficiency level due to a variation in the reliability of the difficulty level, which is described as (Problem 1), is solved. As a result, even if the number of answers is small, or even if there are many answers but they are almost correct answers or they have a too low correct answer rate, the data corresponding to a difficulty level with a low reliability is excluded, and a new proficiency level is calculated based on a difficulty level parameter with a high reliability, so that the reliability of the newly calculated proficiency level can be maintained. Further, only the newly calculated proficiency level with a high reliability is used for updating, so that the reliabilities of the parameters stored in the parameter storage unit 32 can be maintained.

Further, the problem of a lowered reliability of the difficulty level due to a variation in the reliability of the proficiency level, which is described as (Problem 2), is solved. As a result, even if the number of answers from the user is small, or even if the correct answer rate is too high or too low, the data corresponding to a proficiency level with a low reliability is excluded, and a new difficulty level is calculated based on a proficiency level parameter with a high reliability, so that the reliability of the newly calculated difficulty level can be maintained. Further, only the newly calculated difficulty level with a high reliability is used for updating, so that the reliabilities of the parameters stored in the parameter storage unit 32 can be maintained.

If there is a long-term user or a user whose proficiency level has changed significantly, a new proficiency level is calculated using only the newly acquired correct/incorrect answer data, and the new proficiency level is assigned a new user ID according to a difference from the previous proficiency level. This makes it possible to mitigate the problem of a lowered reliability of the proficiency level. Alternatively, dividing the data periodically and assigning a different user ID to a resulting piece of data makes it possible to mitigate the problem of a lowered reliability of the proficiency level.

Further, in terms of the problem that is caused by a small amount of data when the initial scale for difficulty level is fixed, which is described as (Problem 3), it is possible to solve the problem by updating, when an increased number of accumulated data or a lowered reliability is found, such data/parameter to an estimated value based on more pieces of correct/incorrect answer data as necessary.

Furthermore, reducing a sudden change in parameter, such as weighting each of a newly calculated parameter and the previously calculated parameter with the update rate α and adding the resulting parameters, makes it possible to achieve update of parameters with reduced discomfort of the user. Similarly, treating them as time-series data and taking a moving average to smooth out the change also makes it possible to achieve update processing with reduced discomfort of the user.

[Other Embodiments]

Note that the present invention is not limited to the above embodiments. For example, the learning support device 1 is not limited to one used in an online learning system, but may be used for stand-alone learning. Further, as the data treated by the learning support device 1, the correct/incorrect answer data including a binary (correct/incorrect answer) response to an item is described above, but the data is not limited thereto.

The learning support device 1 may be implemented as a single device, and may be configured so that the functional units 21 to 26 included in the learning support device 1 are distributed and deployed on cloud servers, edge servers, and the like to perform the above processing. Alternatively, the learning support device 1 may be provided as one extended function in a user terminal or the like possessed by the user.

In addition, the format of data stored in the correct/incorrect answer data table, the proficiency level table, the difficulty level table, the trigger table, and the like can be variously modified and implemented without departing from the spirit of the present invention.

In short, the present invention is not limited to the above embodiments as they are, and can be embodied by modifying the constituent elements without departing from the spirit of the present invention in an implementation stage. Further, various aspects of the invention can be formed by appropriately combining a plurality of constituent elements disclosed in the above-described embodiments. For example, some constituent elements may be deleted from all the constituent elements illustrated in the embodiments. Furthermore, constituent elements of different embodiments may be combined as appropriate.

### REFERENCE SIGNS LIST

1 Learning support device
10 Input/output interface unit
20 Control unit
21 Correct/incorrect answer data acquisition unit
22 Parameter calculation unit
23 Parameter output control unit
24 Update trigger determination unit
25 Trigger output control unit
26 Proficiency level update control unit
30 Storage unit
31 Correct/incorrect answer data storage unit
32 Parameter storage unit
33 Trigger table storage unit
261 Proficiency level update control unit
262 Difficulty level update control unit
263 Simultaneous update control unit
2611 Data extraction unit
2612 Reference data selection unit
2613 Proficiency level and reliability calculation unit
2614 Reliability determination unit
2621 Data extraction unit
2622 Reference data selection unit
2623 Difficulty level and reliability calculation unit
2624 Reliability determination unit
2631 Reference data selection unit
2632 Proficiency level and difficulty level and reliability calculation unit
2633 Reliability determination unit

1. A learning support device for supporting user learning, comprising: a correct/incorrect answer data acquisition unit that acquires correct/incorrect answer data indicating whether each of answers from a plurality of users to a plurality of items to be learned is correct or incorrect; a parameter calculation unit that calculates, based on the acquired correct/incorrect answer data, a proficiency level indicating an ability level of each user, a difficulty level indicating a difficulty of each item, and reliabilities indicating reliability levels of the proficiency level and the difficulty level; a trigger generation unit that generates a trigger for instruction to update at least one of the calculated proficiency level or difficulty level; and an update control unit that uses, as a reference parameter, at least one of a proficiency level or a difficulty level which has a reliability exceeding a first threshold value among the calculated proficiency levels or difficulty levels to recalculate, in response to the generated trigger, at least one of the proficiency level or the difficulty level which is instructed to be updated by the trigger.

2. The learning support device according to claim 1, wherein, when the number of pieces of correct/incorrect answer data that have not been used for calculating the proficiency level of a specific user exceeds a first number, when an instruction to update the proficiency level of the specific user is received, or when the reliability of the calculated proficiency level of the specific user is lower than a second threshold value and there is any piece of correct/incorrect answer data that has not been used for calculating the proficiency level of the specific user, the trigger generation unit generates a proficiency level update trigger for instructing to update the proficiency level of the specific user.

3. The learning support device according to claim 1, wherein, when the number of pieces of correct/incorrect answer data that have not been used for calculating the difficulty level of a specific item exceeds a second number, when an instruction to update the difficulty level of the specific item is received, or when the reliability of the calculated difficulty level of the specific item is lower than a third threshold value and there is any piece of correct/incorrect answer data that has not been used for calculating the difficulty level of the specific item, the trigger generation unit generates a difficulty level update trigger for instructing to update the difficulty level of the specific item.

4. The learning support device according to claim 1, wherein, when the cumulative number of pieces of correct/incorrect answer data acquired by the correct/incorrect answer data acquisition unit reaches a natural number multiple of a third number, when an instruction to update the proficiency level and the difficulty level at once is received, when an average value of the reliabilities of the proficiency levels of all users or an average value of the reliabilities of the difficulty levels of all items is lower than a fourth threshold value, a ratio of reliabilities that are each lower than a fifth threshold value to the reliabilities of the proficiency levels of all users or among the reliabilities of the difficulty levels of all items exceeds a sixth threshold value, or a coincidence rate between a correct answer rate calculated from the correct/incorrect answer data acquired by the correct/incorrect answer data acquisition unit and a correct answer rate calculated using a relational expression based on the proficiency level and the difficulty level calculated by the parameter calculation unit is lower than a seventh threshold value, the trigger generation unit generates a simultaneous update trigger for instructing to update the proficiency level and the difficulty level at once.

5. The learning support device according to claim 1, wherein the update control unit calculates, when the trigger instructs to update the proficiency level of a specific user, a new proficiency level based on a piece of correct/incorrect answer data that has not been used for calculating the proficiency level among pieces of correct/incorrect answer data that have user identification information associated with the specific user, and the update control unit adds, when a difference between the new proficiency level and the previously calculated proficiency level is larger than an eighth threshold value, new user identification information different from the user identification information of the specific user to the new proficiency level and the piece of correct/incorrect answer data used for calculating the new proficiency level.

6. The learning support device according to claim 1, wherein the update control unit updates the proficiency level or the difficulty level by multiplying the recalculated proficiency level or difficulty level by a weight coefficient and multiplying the previously calculated proficiency level or difficulty level by a weight coefficient and adding the resulting levels, or by taking a moving average based on the recalculated proficiency level or difficulty level and the previously calculated proficiency level or difficulty level.

7. A learning support method executed by a learning support device for supporting user learning, the learning support method comprising the steps of: acquiring correct/incorrect answer data indicating whether each of answers from a plurality of users to a plurality of items to be learned is correct or incorrect; calculating, based on the acquired correct/incorrect answer data, a proficiency level indicating an ability level of each user, a difficulty level indicating a difficulty of each item, and reliabilities indicating reliability levels of the proficiency level and the difficulty level; generating a trigger for instructing to update at least one of the calculated proficiency level or difficulty level; and using, as a reference parameter, at least one of a proficiency level or a difficulty level which has a reliability exceeding a first threshold value among the calculated proficiency levels or difficulty levels to recalculate, in response to the generated trigger, at least one of the proficiency level or the difficulty level which is instructed to be updated by the trigger.

8. A program that causes a processor to execute processing by the units of the learning support device according to any one of claims 1 to 6.
